(19) United States
(12) Patent Application Publication
(10) Pub. No.: US 2019/0126504 A1
(43) Pub. Date: May 2, 2019

(54) Device For Cutting Partial Strips

(71) Applicant: König Maschinen Gesellschaft m.b.H, Graz (AT)

(72) Inventors: Wolfgang Staufer, Wien (AT); Josef Hefner, Dürrwangen (AT); Johann Thormählen, Kollmar (DE); Dieter Sönnichsen, Burg (DE); Hannes Stelzer, Lannach (AT); Gernot Maier, Hart bei Graz (AT)

(21) Appl. No.: 16/087,983

(22) PCT Filed: Mar. 23, 2017
(86) PCT No.: PCT/AT2017/060075

§ 371 Date: Sep. 24, 2018

(30) Foreign Application Priority Data
Mar. 24, 2016 (AT) A157/2016
Mar. 24, 2016 (AT) A158/2016
Jun. 17, 2016 (AT) A50555/2016

(51) Int. Cl. B26D 1/16; B26D 5/00; A21C 5/00

(52) U.S. Cl. CPC B26D 1/165; A21C 5/00; B26D 5/007

(57) ABSTRACT

A device for cutting partial strips having a defined specifiable mass, preferably from a dough strip, including at least one cutting unit, which has a blade. The cutting unit is adjustably fastened to a retaining element of the device in such a way that the blades cut a dough strip, which is conveyed past the device and is moved in the longitudinal direction of the dough strip, into at least two partial pieces predominantly parallel to the direction of motion of the dough strip. The cutting unit includes an adjustment mechanism, wherein the adjustment mechanism is designed in such a way that the position of the blade can be adjusted with respect to the position of the cutting unit, in particular over the width of the dough strip, by automated control.

### TECHNICAL FIELD

The present teaching relates to a device for cutting partial strips having a defined specifiable width from a dough strip.

### BACKGROUND

In the prior art, dough strips on dough strip devices are adjusted to a specified dough thickness by means of calibrating rollers or other rollers. Particular attention is taken to ensure that the calibrating rollers or other rollers are at the same distance from one another in order to achieve homogeneous thickness of the dough strip. In addition, in the prior art with longitudinal cutting units in dough strip devices, the cutting width of partial pieces or partial strips from one dough strip is adjusted as defined. The cutting width of the longitudinal cutting unit is adjusted in such a way that strips are cut to a constant width without considerations of differences in weight of the individual partial strips.

However, because, for the sake of consumer protection, the weight of individual finished baked goods must weigh at least the weight that is indicated and since the weight data for partial pieces and partial strips is provided by weight rather than by number of items, a baking operation is obliged to produce baked goods at the precisely indicated weight or at greater weight. The average baked good is therefore produced at greater weight than indicated in order to counteract any deviation in manufacturing. This leads to a disadvantage in production efficiency and increases the raw materials costs. The more precisely machines can produce dough pieces with a uniform weight, the less loss of raw material occurs for the baking operation.

With known dough strip devices, the weight of pre-cut dough pieces is recorded by scales and underweight dough pieces are excluded because underweight dough pieces may not be sold. If the measured weight of the finished dough pieces exceeds a certain figure, then the dough strip device is brought to a stop and the cutting device is re-adjusted to minimize rejects. This production halt reduces the hourly output of dough pieces and thus increases costs enormously and has an impact on the costs of a completed dough piece. Dough strip devices known in the prior art, depending on the dough and cutting sizes, can contain approximately 5-20% weight precision per dough piece.

### SUMMARY

It is one object of the present teaching to clearly improve this weight precision of individual dough strips and to reduce production costs.

This object is achieved through the defining features that the cutting unit comprises an adjustment mechanism wherein the adjustment mechanism is configured so that the position of the blade with respect to the position of the cutting unit can be adjusted over the width of the dough strip, especially via automatic control.

Because of the adjustable position of the blade of the cutting device, a slight adjusting motion can occur even in a very brief time (a few milliseconds) and the cutting width can be adjusted during ongoing operation. Thus weight differences in dough pieces and dough strips caused by production can be prevented in advance without the need to bring a dough strip device or the cutting device to a stop.

Particularly advantageous embodiments of the device are defined in greater detail by the features of the dependent claims.

A preferred, easily produced embodiment of the device foresees that the adjustment mechanism comprises a power drive, in particular a motor, and a mechanical adjustment unit, in particular including a ramp, ball ramp, helical gear mechanism, screw or threaded spindle that can be adjusted by the power drive, wherein upon adjustment of the mechanical adjustment unit, in particular the ramp, ball ramp, helical gear mechanism, screw or threaded spindle, the position of the blade can be adjusted to the position of the cutting unit and/or that the adjustment mechanism comprises a pneumatic or hydraulic cylinder, by means of which the blade is adjustable.

The dough of the dough strip can simply be cut without compressing the dough or causing additional friction when the blade is configured as a cutting disc and can be powered by rotation of a shaft, in particular a power drivable shaft, and wherein the blade can be moved along the axis of the shaft by the adjustment mechanism.

It is possible simply to adjust the blade if the adjustment mechanism comprises at least an adjustment disc that is power by a power drive, in particular a motor, is configured as disc-shaped and is positioned parallel to the blade, in particular along the axis of the shaft at a distance from the blade, wherein on one of the front sides of the adjustment disc one ramp or in particular three ramps are positioned, wherein on the blade a ramp receiver is configured, in particular mirror-inverted to the ramp, wherein the ramp is contiguous with the ramp receiver, wherein the ramp, in particular uniformly, rises in the direction of the axis of the adjustment disc in such a way that upon adjustment, preferably rotation, of the adjustment disc by the motor, the ramp is moved and the position of the blade is changed with respect to the position of the cutting unit, as the distance of the blade from the adjustment disc is increased or reduced.

An improved embodiment of the device can be provided if the ramp comprises a spiral- or circular-shaped course, in particular with a constant radius, or is configured as screw-shaped, in particular with a specified uniform rise.

In order to fix the blade's position and to guarantee that the ramp is always contiguous with the ramp receiver, it is possible to foresee that the adjustment mechanism comprises at least one, in particular three, return springs, wherein the return spring is configured in such a way that it exerts a power impact on the blade against the rise of the ramp, ball ramp, helical gear mechanism, screw or threaded spindle and, in particular, reduces the blade's distance from the cutting unit, in particular from the adjustment disc.

The adjustment mechanism can be adjusted easily if the adjustment disc comprises a toothed connection wherein the adjustment disc can be moved by the motor by means of a belt drive or a chain, wherein the device comprises a tensing element, in particular a chain tensioner to tense the belt drive or chain.

Several parallel dough strands with specified modifiable width can easily be produced simultaneously if the device comprises several, preferably four, identically configured cutting units, each with a blade, wherein the cutting units are positioned on the retaining element at a distance, in particular a uniform distance, from one another, wherein the blades of the cutting units are positioned parallel to one another, wherein a dough strip conveyed past the device is divided into several partial pieces, preferably with an equal weight per longitudinal unit, wherein each blade can be moved by the respective adjustment mechanism in each case with respect to the other blades and/or to the respective cutting units along the width of the dough strip.

A preferred configuration of the device foresees that the position of the blade with respect to the cutting device, in particular to the adjustment blade, is adjustable by less than 100 mm, preferably less than 32 mm, particularly preferably less than 10 mm, in particular in each case by less than 1 mm, preferably less than 0.1 mm.

To guarantee the slippage-free transmission between power drive and adjustment mechanism and in order to allow manual pre-positioning of the base position, it can be foreseen that the cutting unit is secured to the retaining element by means of a tensing mechanism, wherein the cutting unit can be moved, in particular manually, in particular by sliding, on the retaining element after opening the tensing mechanism and in such a way it is possible to pre-select the width of the cut partial pieces of the dough strip or the position of the blade with respect to the dough strip.

To achieve precisely weighed production of partial strips or dough pieces, it is possible to foresee that the device comprises a control unit with which the position of the blade, in particular of the blades, with respect to the dough strip can be adjusted and specified, wherein in particular the position of the blades can be modified by the control unit corresponding to the mass distribution along the width of the dough strip in such a way that partial pieces of equal weight per longitudinal unit are cut by the device.

It is advantageous to foresee that the control unit, in addition, is configured in such a way that upon adjusting one of the blades by the control unit by a defined value, the other blades can automatically be adjusted by the same value in the same direction.

To be able to adjust the blade's position simply, precisely and in a controlled manner, it is foreseen that the device should comprise a regulating sensor system and at least one positioning sensor to determine the position of the blade, in particular a number of positioning sensors corresponding to the number of blades, wherein the regulating sensor system is configured in such a way that the automated adjustment of the blade can be influenced by the position of the blade and/or of the adjustment mechanism as determined by the positioning sensor, wherein the positioning sensor is preferably configured as an absolute sensor or reference sensor.

The geometrical configuration and thus the required cutting width of a dough strip can advantageously be adjusted if the device comprises a 3D laser scanner or a unit for video analysis of the dough strip's geometry, wherein the control unit is configured in such a way that the regulation of the blade position is adjustable on the basis of the geometry of the dough strip determined by the 3D laser scanner or the unit for video analysis of the dough strip geometry.

Preferred automatic pre-positioning of the cutting unit can be achieved if the device comprises a positioning unit, with which a pre-positioning of the cutting unit on the retaining element can be adjusted automatically, wherein in particular the pre-positioning of the cutting unit on the retaining element can be specified according to the product that is to be produced. This makes automatic product exchange possible without manual intervention. By means of automated pre-positioning of the cutting units, an approximate regulation with great adjustment distance can be achieved, with simultaneous fine regulation of the blade position by means of the adjustment mechanism.

To allow a variable number of cutting units to be employed, without distancing them from the device or to be adjusted again, it is possible to foresee that the retaining element is extended beyond the area in which the dough strip is transported within the device, wherein the retaining element comprises a parking area for at least one cutting unit that is configured in such a way that, by modifying the number of required cutting units, the non-required cutting units can be shifted into the parking area, so that the blades of the cutting units located in the parking area do not cut the dough strip or are removed from it.

A preferred application of the device foresees that a dough strip device comprises an inventive device, in front of which a weighing apparatus is placed to measure the mass distribution along the width of a strip moved along its longitudinal direction and/or that the dough strip device or the device comprises a control unit with which the cutting width of the cutting unit, in particular the position of the blade over the width of the dough strip, is specified in such a way, while taking into account the weight distribution along the width of the strip as ascertained by the weighing apparatus, that the continuous partial pieces cut by the device in the longitudinal direction of the strip have equal mass per longitudinal unit.

Additional advantages and configurations of the present teaching can be seen from the description and the attached drawings.

### BRIEF DESCRIPTION OF THE DRAWINGS

The present teaching is presented schematically hereinafter in the drawings on the basis of particularly advantageous embodiments, which however are not to be interpreted restrictively, and is described by way of example with reference to the drawings.

FIG. 1 shows an isometric view of the inventive apparatus.

FIG. 2 shows an isometric view of an embodiment of the cutting unit.

FIGS. 3 and 3a show the cutting unit, in two extreme positions.

FIG. 4 shows a section through the main mounting of the cutting unit.

FIG. 5 shows a lateral view of the cutting unit with depiction of the chain path.

FIG. 6 shows an isometric view of the housing of the cutting unit.

FIG. 7 shows an isometric view of an adjustment disc.

FIG. 8 shows an isometric view of a blade.

FIG. 9 shows an isometric view of a retainer with power-driven shaft.

### DETAILED DESCRIPTION

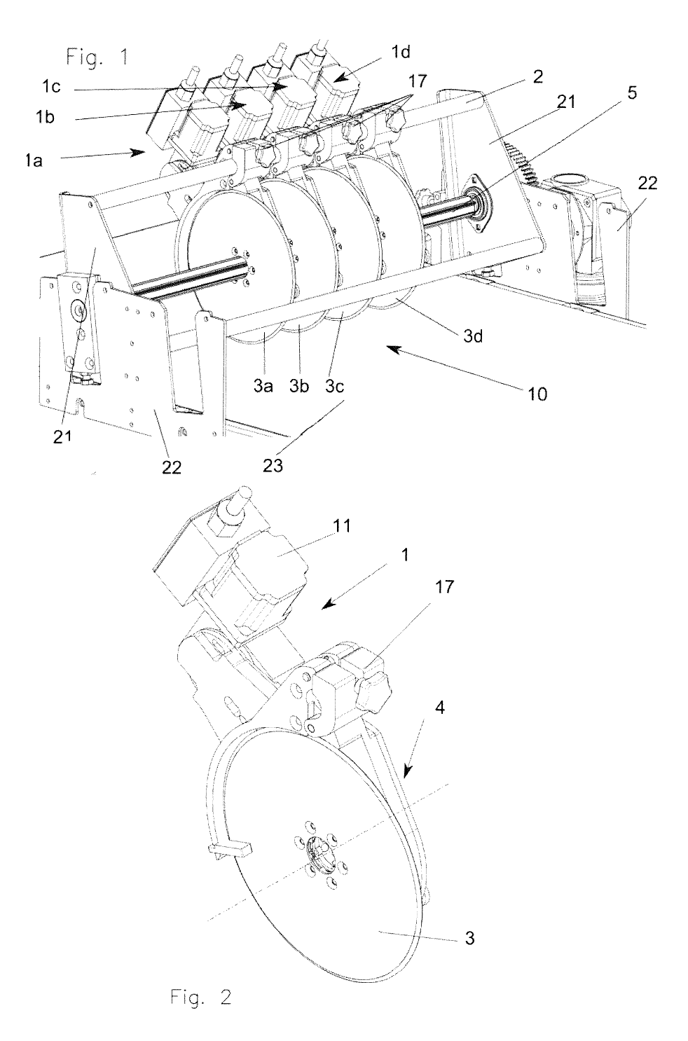

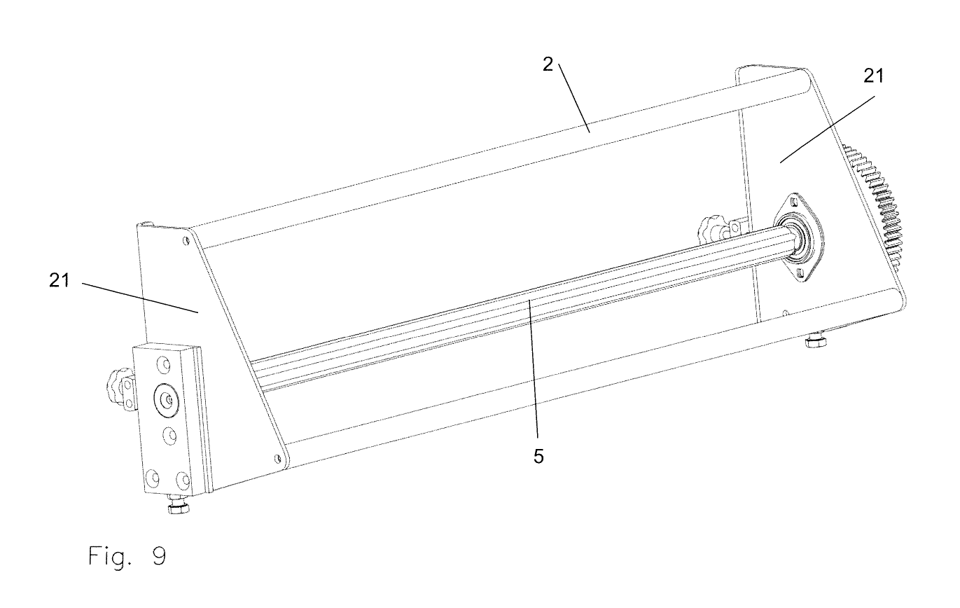

FIG. 1 shows an inventive apparatus 10 in an isometric view. The device 10 comprises a retaining element 2, which is configured as a rod with a round cross-section and is retained at the ends with two lateral parts 21 (FIG. 9). The lateral parts 21 are secured on the frame 22 of the device 10, wherein the retaining element 2 is positioned along the width of a conveyor belt 23 above it at a distance parallel to the width of the conveyor belt 23. During operation, a dough strip (not illustrated) is placed on the conveyor belt 23 and is conveyed along its longitudinal direction past the device 10 or through it.

In addition, the device 10 comprises four identically configured cutting units 1a, 1b, 1c, 1d that are fastened to the retaining element 2 by means of a tensing mechanism 17. Each cutting unit 1a, 1b, 1c, 1d comprises a blade 3a, 3b, 3c, 3d, which is configured as a cutting disc. The blades 3a, 3b, 3c, 3d are aligned on the cutting units 1a, 1b, 1c, 1d in the direction of motion of the dough strip or of the conveyor belt 3 and sever or cut the dough strip into five partial pieces. The device 10 comprises a shaft 5, which is positioned parallel to the retaining element 2 and passes through the blades 3a, 3b, 3c, 3d in their midpoint in each case and drives them by rotation. The blades 3a, 3b, 3c, 3d are connected with the shaft by a carrier 31, transmitting torque (FIG. 7). The direction of rotation of the blades 3a, 3b, 3c, 3d can thus be counter to or with the movement of direction of the dough strip or can be blocked.

The cutting units 1a, 1b, 1c, 1d, after opening the respective tensing mechanism 17, can be manually displaced on the retaining element 2 or can be slid along the length of the shaft, that is, along the width of the dough strip, or can be removed from the retaining element 2. This results in a pre-adjustment of the width of the cut partial pieces of the dough strip or of the position of the blade 3 with respect to the dough strip or to the width of the conveyor belt 23.

Shown in FIG. 2 is an isometric view of an embodiment of a cutting unit 1. The cutting unit 1 comprises an adjustment mechanism 4, which displaces the blade along the axis in the shaft 5 inserted in the center recess of the blade 3 (FIG. 1). By displacing the blade 3 by the adjustment mechanism, the position of the blade 3 with respect to the cutting direction 1 and thus the position of the blade 3 along the width of the dough strip is adjusted under automated control.

The adjustment mechanism 4 comprises a power drive, in this embodiment an electrical motor 11. The motor 11, by means of a connecting element, in this embodiment a chain 13, displaces a mechanical adjustment unit, which comprises a ramp 14 that modifies the position of the blade 3 with respect to the position of the cutting unit 1 (FIG. 7). The cutting unit, in addition, comprises a tensing element to tense the belt drive or chain 13, in the embodiment shown in FIG. 5 a chain tensioner 19.

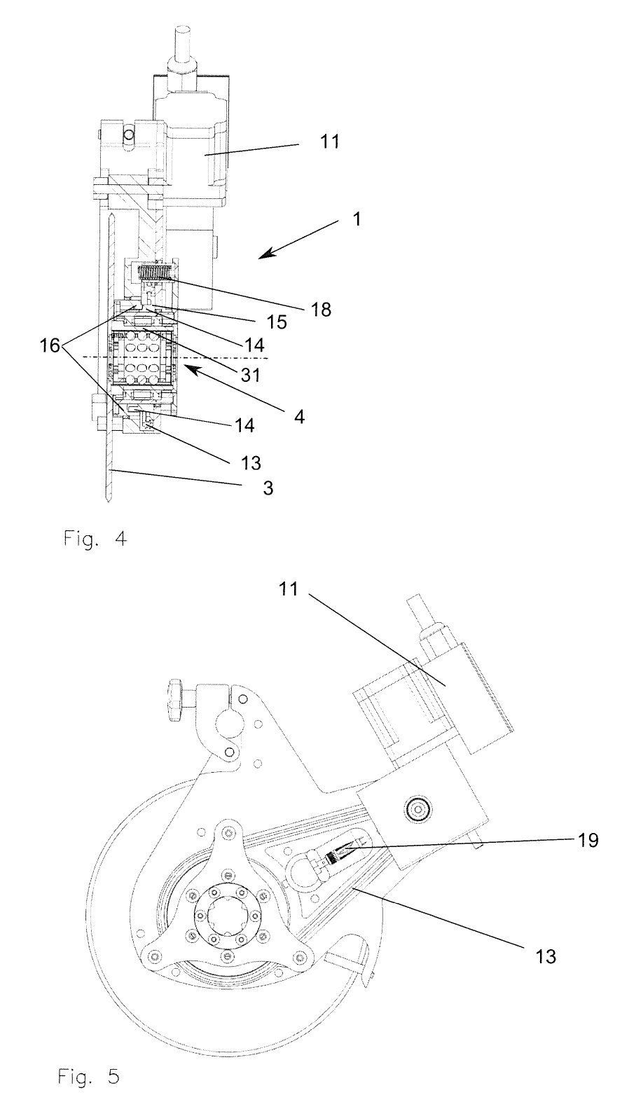

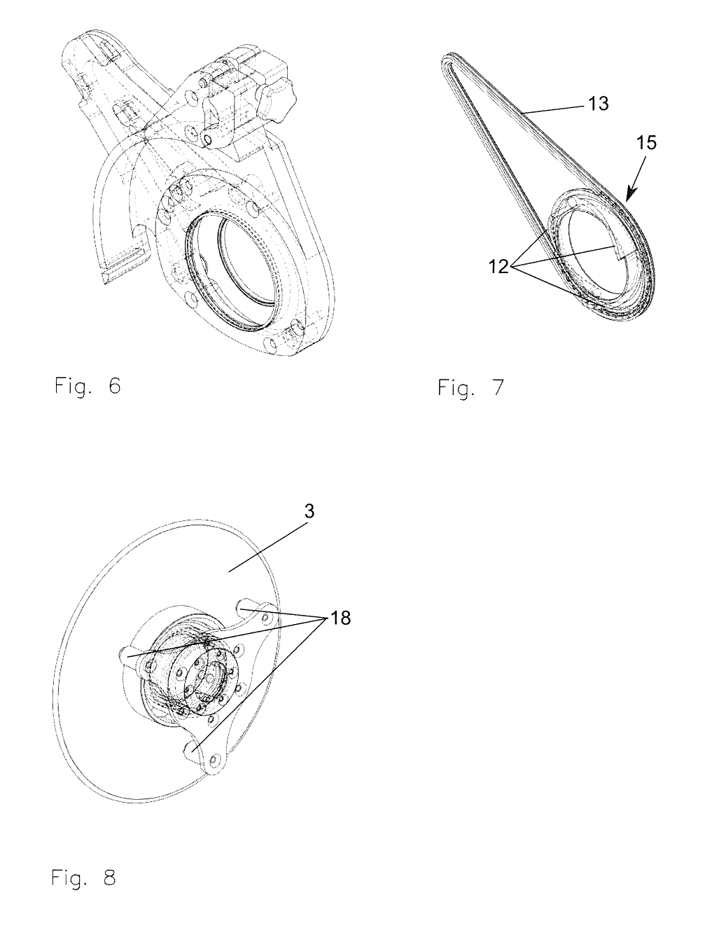

FIG. 4 shows a section through the main mounting of a preferred embodiment of the cutting unit 1. The cutting unit 1 comprises a blade 3 configured as a blade disc, which can be powered by a shaft 5 depicted as in FIG. 1. The cutting unit 1 further comprises an adjustment mechanism 4 with a mechanical adjustment unit, said mechanism modifying the position of the blade 3 with respect to the position of the cutting unit 1. The adjustment mechanism 4 comprises an electrical motor 11, which is connected by a chain 13 with the mechanical adjustment unit, which in this embodiment is configured as a disc-shaped adjustment disc 15 (FIG. 6 and FIG. 7). The adjustment disc 15 is mounted rotatably in the axis of the blade 3 (FIG. 7) on the carrier 31 of the blade 3 independently of it. The adjustment disc 15 comprises a toothed periphery, into which the chain 13 engages and rotates the adjustment disc 15, upon powering by the motor 11, over a defined portion of the periphery in its axis, that is, in the axis of a shaft 5 inserted into the recess of the blade 3. The adjustment disc 15 is positioned along the axis of the blade 3 at a distance from the blade 3. On one of the front sides of the adjustment disc 15, three ramps 14 are positioned equidistant to one another on the periphery. The ramps 14 comprise a circular course with respect to the center point of the adjustment disc 15, and thus extend along the same radius and comprise an equal, constant slope. The ramps 14 comprise a rising height in the clockwise direction and therefore, at the more distant end seen clockwise, along the axis of the adjustment disc 15, are thicker than at the other end. Configured on the blade 3 are three ramp receivers 16, mirror-inverted to the ramp 14, and which each are contiguous with the ramp 14 opposite the respective ramp receiver 18.

When the motor 11 moves the adjustment disc 15 by the chain 13, the adjustment disc 15 is rotated in its axis about a portion of the periphery, as seen looking clockwise toward the ramps 14. Because of the slope of the ramps 14, the ramp receiver 16, which is secured against rotation, is moved along the axis of the adjustment disc 15 or of the blade 3 or along the width of the dough strip and of the shaft 5, and thus the position of the blade 3 is modified with respect to the cutting device 1 or the distance X is increased and thus the cutting width of the partial pieces of the dough strip is modified. If the adjustment disc 15 is rotated in counterclockwise direction, the distance X is analogously reduced.

In the embodiments of the device 10 shown in FIG. 4, FIG. 5 and FIG. 6, or of the cutting unit 1, the adjustment mechanism 4 comprises three return springs 18, wherein the return springs 18 are distributed uniformly in the same radius with reference to the center axis of the blade 3 (FIG. 8). The force exerted by the return springs 18 acts against the slope of the ramps 14, so that they cause a return of the blade 3 against the power drive of the motor 11 or modify the position of the blade 3 with respect to the cutting unit 1, so that the distance X between the blade 3 and the adjustment disc 15 is reduced. The return springs 18, as shown for example in FIG. 7, are connected by intermediate parts in each case with the blade 3 and the adjustment disc 15. In addition, through the force exerted by the return springs 18, the position of the blade 3 can be secured. Thus, an undesired displacement of the blade 3 by the force exerted by the dough or other impacts can be prevented. Simultaneously, overload protection for the components in use is provided by the return springs 18.

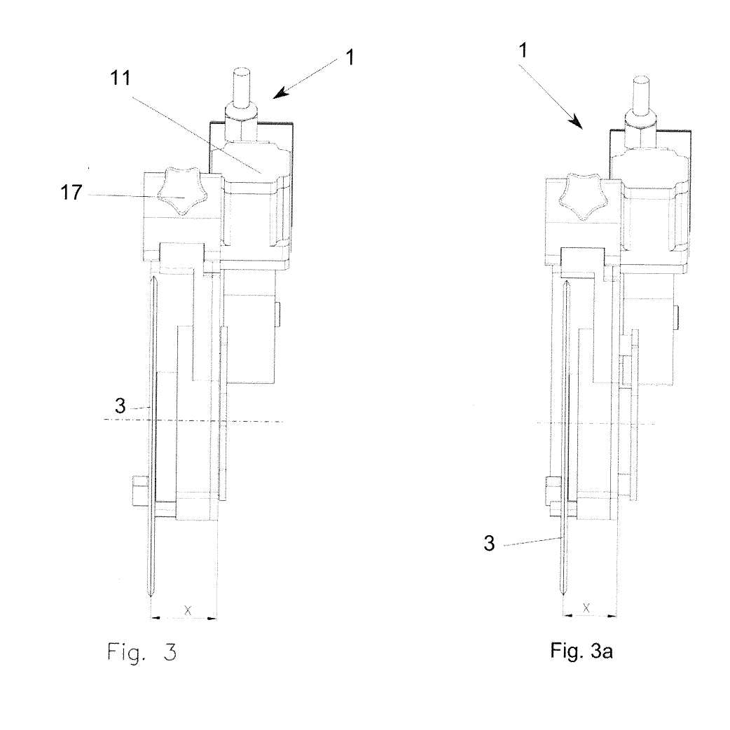

FIG. 3 and FIG. 3a each show an end or extreme position of the blade 3 displaced by the adjustment mechanism 4. The position of the blade 3 with respect to the cutting device 1 can be moved by the distance X in the direction of the axis of the blade 3 configured as a cutting disc. The distance X or the position of the blade 3 with respect to the cutting unit is preferably adjustable by less than 100 mm, preferably less than 32 mm, particularly preferably less than 16 mm, wherein the displacement occurs advantageously in steps of less than 1 mm, preferably less than 0.1 mm.

Alternatively, the blade 3 can be moved by other mechanical adjustment units, which alternatively comprise a ball ramp, a helical gear mechanism, screw or threaded spindle, or the latter or the ramp 14 can also run in a spiral shape to a front end of the adjustment disc 15. The ramps 14 alternatively can also be configured in screw shape or can comprise a profiled configuration. In addition, the motion can also be made by a pneumatic or hydraulic cylinder.

As an alternative, the blade 3 or the cutting disc can also be powered by the strip situated below it or by a drive roller.

An application of the inventive apparatus 10 foresees that the latter is positioned or used inside a dough strip device. Thus, a weighing apparatus, for instance, can be placed ahead of the device 10 and by this means the measurement of the mass distribution along the width of the dough strip moved along its longitudinal direction is recorded. The cutting width of the cutting unit 1 or of the cutting units 1a, 1b, 1c, 1d can be specified, for example, by a control unit using the ascertained mass distribution of the strip, so that the continuous partial pieces or partial strips cut by the device 10 along the longitudinal direction of the strip comprise an equal mass per longitudinal unit of the partial strip. Using the transport speed and the mass distribution of the dough strip recorded over time as well as the positioning of the device 10 with respect to the weighing apparatus, dough pieces or dough strips with equal mass can always be generated time-dependently, by moving the cutting units 1a, 1b, 1c, 1d. As a result, there is an advance impact on the cutting by the device 10 or by the cutting units 1a, 1b, 1c, 1d and production is kept free of rejects and precise in weight. For example, in the event that a portion of dough that is to be cut is too heavy, the cutting width for this portion can be reduced by moving a blade 3a, 3b, 3c, 3d and thus the weight can be adjusted. Because this can have effects on the cutting width of nearby partial pieces, the cutting width of the additional partial pieces and thus the position of the other blades 3a, 3b, 3c, 3d with respect to the other cutting units 1a, 1b, 1c, 1d can advantageously be displaced by the same value in the same direction as the first blade. Alternatively, as a further action, the longitudinal cut of the dough strip or dough strips can be adjusted. For example, on the basis of the determined mass distribution, the blade 3a of cutting unit 1a is moved by 0.5 mm, automatically causing the blades 3a, 3b, 3c of the nearby cutting units 1b, 1c, 1d also to be displaced or moved back by 0.5 mm, in order to produce the other nearby dough pieces or produced partial strips to a precise weight. In addition, however, by means of the control unit, as described, a different displacement of each cutting unit 1a, 1b, 1c, 1d can be determined and specified, in order to generate all partial strips, that is, five partial strips in the embodiment of FIG. 1, with an equal mass per longitudinal unit.

The weighing unit, for example, can be configured as a weight-measuring unit, or can ascertain irregularities or differences in weight along the width and/or length of the dough strip by means of a laser scanner or with roentgen radiation and on that basis can provide a different cutting width for the partial pieces of the dough strip.

Advantageously, the mounting within the adjustment unit 4 can be made with as free of play as possible. In addition, the precision of the longitudinal cutting device and regularity can be increased by means of high ratios in the longitudinal adjustment of the blades 3a, 3b, 3c, 3d or in the adjustment mechanism 4, for example by integration of a gearbox in the motor 11 or by selection of the ratio setting between the adjustment disc 15 and the motor 11. Because strip speeds in dough strip devices in the field of longitudinal cutting units, such as the device 10, normally run relatively slowly (to approximately 20 m/min), a relatively high ratio can be used for the adjustment in order to increase precision and reduce adjustment speed.

Alternatively, other blades 3, such as a cutting disc or a straight-shaped blade or else an ultrasound blade, can be used. Here too, a parallel arrangement of several cutting elements is advantageous.

It is advantageous if the precise position of the adjustment mechanism 4 or of the blade 3 is known, in order to allow better control of the regulation. For this purpose, a rotary encoder or a linear sensor with a corresponding resolution can be integrated into the adjustment mechanism 4 and/or the motor 11.

The control unit can advantageously be configured or programmed in such a way that, upon moving one of the blades 3a, 3b, 3c, 3d by the control unit by a defined value, the blades 3a, 3b, 3c, 3d situated contrary to the adjustment direction are automatically moved by the same value.

In addition, the device 10 can optionally comprise a regulating sensor system and a positioning sensor or one positioning sensor for each blade 3a, 3b, 3c, 3d or cutting unit 1a, 1b, 1c, 1d. The position of the blade 3 or blades 3a, 3b, 3c, 3d is determined and transmitted to the regulating sensor system by the positioning sensor. Displacement of the blade 3 or of each blade 3a, 3b, 3c, 3d can be monitored by the positioning sensor and transmitted to the regulating sensor system, and thus a precise positioning of the blades 3a, 3b, 3c, 3d or of the respective adjustment mechanism 4 can be obtained or their position can be readjusted. The position monitors can be configured as absolute sensors and can monitor the position of the blades 3a, 3b, 3c, 3d absolutely, for example with reference to one specified neutral point, for example one end of the width of the dough strip, or can be configured as relative sensors and determine the position of the blades 3a, 3b, 3c, 3d with respect to one another.

Optionally, the device 10 can comprise a 3D laser scanner or a unit for video analysis of the geometry of the dough strip, and thus can serve to register the geometry of the dough strip, that is, the thickness, width, variation in thickness over the width and so on. Then the regulation of the position of the blade 3 or of the blades 3a, 3b, 3c, 3d can be adjusted by means of the control unit, on the basis of the geometry of the dough strip determined by the 3D laser scanner or the unit for video analysis, and thus, for example in the event of differing thickness along the width of the dough strip, partial pieces with equal weight or partial strips with equal weight per longitudinal unit, but for example with differing width, can be cut.

As an alternative to manual adjustment of the cutting unit 1 on the retaining element 2, the device 10 can comprise a positioning unit by which a pre-positioning of the cutting unit 1 on the retaining element 2 is automatically selected. Thus, for example, the pre-positioning can be selected depending on the product to be produced, and the cutting units 1a, 1b, 1c, 1d can be positioned at equal distance from one another. The displacement of the cutting width or of the blades 3a, 3b, 3c, 3d, in addition, can be finely adjusted corresponding to the determined mass distribution along the width of the dough strip. This makes automatic product replacement possible without manual intervention. By means of automatic repositioning, a rough regulation with a large displacement distance (1600 mm or greater) becomes possible and fine regulation (<0.1 mm) can occur by means of the adjustment mechanism 4.

Optionally, in addition, it is possible to foresee that the retaining element 2 configured as a rod extends beyond the area in which the dough strip is transported within the device. Thus, over a certain length on the retaining element 2, no dough strip is positioned below this one and thus a parking area for a cutting unit 1 is configured. Then, if, by the replacement of a product that is to be produced or on account of the mass distribution along the width of the dough strip, one of the cutting units 1a, 1b, 1c, 1d is no longer required, it can be slid manually or by means of the positioning unit into the parking area, so that the blade 3a, 3b, 3c, 3d of the slid cutting unit 1a, 1b, 1c, 1d is no longer in contact with the dough and remains there until it is needed again. Alternatively, the blade 3a, 3b, 3c, 3d of the cutting unit 1a, 1b, 1c, 1d that is no longer required can be removed from the dough strip.

In addition, the device 10 can also comprise a simple exchange system in order to be able to easily modify the number of cutting units 1a, 1b, 1c, 1d disposed on the retaining element 2. This is possible, for example, by means of a shaft mounted flush on one side, which makes it possible to easily push the blades 3a, 3b, 3c, 3d, configured as cutting discs, upward onto the shaft.

To be able to achieve simplified regulation and also to use cheaper powering components, filtered position regulation can be adopted and integrated into the control unit or the control of the motor 11 or of the adjustment mechanism 4.

1. A device for cutting partial strips having a defined specifiable mass, preferably from a dough strip, comprising at least one cutting unit including a blade, such that the cutting unit is adjustably fastened to a retaining element of the device in such a way that the blades cut a dough strip, which is conveyed past the device and is moved in the longitudinal direction of the dough strip, into at least two partial pieces predominantly parallel to the direction of motion of the dough strip, wherein the cutting unit includes an adjustment mechanism, wherein the adjustment mechanism is designed in such a way that the position of the blade can be adjusted with respect to the position of the cutting unit, in particular over the width of the dough strip, by automated control.

2. The device according to claim 1, wherein the adjustment mechanism includes a power drive, in particular a motor, and a mechanical adjustment unit, in particular including a ramp, ball ramp, helical gear mechanism, screw or threaded spindle, which can be adjusted by the power drive, wherein upon moving the mechanical adjuster unit, in particular, the ramp, ball ramp, helical gear mechanism, screw or threaded spindle, the position of the blade with respect to the position of the cutting unit can be adjusted and/or that the adjustment mechanism includes a pneumatic or hydraulic cylinder, by means of which the blade is adjustable.

3. The device according to claim 1, wherein the blade is configured as a cutting disc and can be powered by rotation by a shaft, in particular one that is power driven, and wherein the blade can be moved along the axis of the shaft by the adjustment mechanism.

4. The device according to claim 1, wherein the adjustment mechanism includes at least one disc-shaped adjustment disc powered by a power drive, in particular a motor, wherein said disc is positioned parallel to the blade, in particular along the axis of the shaft, at a distance from the blade, wherein one, or in particular three, ramps are positioned at one of the front sides of the adjustment disc, wherein a ramp receiver, in particular, is configured as mirror-inverted to the ramp, wherein the ramp is contiguous with the ramp receiver, wherein the ramp, rises, in particular uniformly, in the direction of the axis of the adjustment disc, in such a way that in the event of displacement, preferably rotation, of the adjustment disc by the motor, the ramp is displaced and the position of the blade is modified with respect to the position of the cutting unit, in that the distance of the blade from the displacement disc is increased or reduced.

5. The device according to claim 4, wherein the ramp includes a spiral-shaped or round-shaped course, in particular with a constant radius, or is configured as screw-shaped, in particular with a specified uniform rise.

6. The device according to claim 2, wherein the adjustment mechanism includes at least one, in particular three return springs, wherein the return spring is positioned in such a way that it exerts a force on the blade contrary to the rise of the ramp, ball ramp, helical gear mechanism, screw or threaded spindle and, in particular, reduces the distance of the blade from the cutting unit, in particular from the adjustment disc.

7. The device according to claim 4, wherein the adjustment disc includes teeth, wherein the adjustment disc can be displaced by the motor by means of a belt drive or a chain, wherein the device include a tensing element, in particular a chain tensioner to tense the belt drive or chain.

8. The device according to claim 1, wherein the device includes several, preferably four equally configured cutting units each having a blade, wherein the cutting units are positioned on the retaining element at a distance, preferably uniform, from one another, wherein the blades of the cutting units are positioned parallel to one another so that a dough strip conveyed past the device is divided into several partial pieces, preferably having equal weight per longitudinal unit, wherein each blade can be displaced with respect to the other blades and/or the respective cutting units along the width of the dough strip by the respective adjustment mechanism.

9. The device according to claim 1, wherein the position of the blade with respect to the cutting device, in particular with respect to the adjustment disc, can be moved by less than 100 mm.

10. The device according to claim 1, wherein the cutting unit can be secured on the retaining element by means of a tensing mechanism, wherein the cutting unit can be displaced, particularly slid, by means of a tensing mechanism on the retaining element, wherein the cutting unit after opening of the tensing mechanism can be displaced, particularly slid, on the retaining element, in particular manually and in such a manner a pre-selection of the width of the cut partial pieces of the dough strip or of the position of the blade with respect to the dough strip can occur.

11. The device according to claim 1, wherein the device includes a control unit, by which the position of the blade, in particular of the blades, with respect to the dough strip can be adjusted and specified, wherein in particular the position of the blade can be modified by the control unit, corresponding to the mass distribution along the width of the dough strip, in such a way that partial pieces with equal weight per longitudinal unit are cut by the device.

12. The device according to claim 11, wherein the control unit is configured in such a way that, when one of the blades is displaced by the control unit by a defined value, the other blades are automatically displaced by the same value in the same direction.

13. The device according to claim 1, wherein the device includes a regulating sensor system and at least one positioning sensor to determine the position of the blade, in particular a number of positioning sensors corresponding to the number of blades, wherein the regulating sensor system is configured in such a way that the automated displacement of the blade can be influenced by the position of the blade and/or of the adjustment mechanism obtained by the positioning sensor, wherein preferably the positioning sensor is configured as an absolute sensor or reference sensor.

14. The device according to claim 12, wherein the device includes a 3D laser scanner or a unit for video analysis of the geometry of the dough strip, wherein the control unit is configured in such a way that the regulation of the position of the blade can be adjusted on the basis of the geometry provided by the 3D laser scanner or the unit for video analysis of the geometry of the dough strip.

15. The device according to claim 1, wherein the device includes a positioning unit with which a pre-positioning of the cutting unit on the retaining element can be automatically adjusted, wherein in particular the pre-positioning of the cutting unit on the retaining element can be specified according to the product to be produced.

16. The device according to claim 1, wherein the retaining element extends beyond the area in which the dough strip is transported within the device, wherein the retaining element includes a parking area for at least one cutting unit that is configured in such a way that in modifying the number of required cutting units, the cutting units not required can be moved into the parking area so that the blades of the cutting units situated in the parking area do not cut the dough strip or are removed from it.

17. A dough strip device including a device according to claim 1, wherein a weighing apparatus for measuring the mass distribution along the width of a strip moved along its longitudinal direction is placed before the device and/or wherein the dough strip device or the device includes a control unit with which the cutting width of the cutting unit, in particular the position of the blade over the width of the dough strip, can be specified in such a way while taking into account the weight distribution along the width of the strip ascertained by the weighing apparatus, so that the continuous partial pieces cut by the device in the longitudinal direction of the strip include the same mass per longitudinal unit.
